(19) United States
(12) Patent Application Publication
(10) Pub. No.: US 2026/0338980 A1
(43) Pub. Date: Oct. 29, 2026

(54) METHOD AND SYSTEM FOR FACIES TYPE CLASSIFICATION IN A RESERVOIR GEOLOGICAL FORMATION

(71) Applicant: TotalEnergies OneTech, Courbevoie (FR)

(72) Inventor: Pierre Thore, Pau (FR)

(21) Appl. No.: 19/124,162

(22) PCT Filed: Oct. 27, 2022
(86) PCT No.: PCT/IB2022/000630

§ 371 Date: Apr. 24, 2025

(51) Int. Cl. G01V 1/30; G01V 1/34

(52) U.S. Cl. CPC G01V 1/308; G01V 1/345; G01V 2210/6246; G01V 2210/64

(57) ABSTRACT

A computer implemented method for facies type classification in a reservoir geological formation, comprising absolute value of the, for a considered portion among a plurality of portions composing the reservoir geological formation: retrieving, from a 3D seismic image, at least one geophysical property value associated with the considered portion, retrieving, from a 4D seismic image, at least one time-lapse geophysical property value associated with the considered portion, and for each of a plurality of different facies types: determining a facies type likelihood based on the retrieved at least one geophysical property value and based on the retrieved at least one time-lapse geophysical property value, wherein said facies type likelihood is representative of a probability that the considered portion belongs to said facies type and is determined by using a predetermined facies-type-specific multivariate probability distribution.

### BACKGROUND

### Technical Field

This disclosure relates to the field of reservoir geological formations modeling and exploitation and relates more particularly to a method and system for facies type classification in a reservoir geological formation.

### Description of the Related Art

In the field of hydrocarbon (oil, natural gas, shale gas, etc.) recovery from an underground reservoir geological formation, it is important to be able to build reservoir models in order to be able to predict an amount of hydrocarbon that can be recovered from the reservoir geological formation. This is also important in the field of carbon capture utilization and storage (CCUS), in order to be able to predict an amount of carbon dioxide that can be stored in said reservoir geological formation.

In particular, it is important to be able to perform a facies type classification of the reservoir geological formation, i.e., to be able to estimate a spatial distribution of a plurality of different facies types inside the reservoir geological formation.

For instance, facies type classification can use supervised techniques which perform facies type classification by using training data. Such training data is usually built by using measurements performed at one or more wells arranged in the reservoir geological formation. Since the spatial distribution of the different facies types along the well(s) can be accurately identified, the training data usually comprises values of geophysical properties (e.g., V_{P}/V_{S} ratio, Poisson ratio, density, etc.) and the associated facies types as identified along the well(s). This training data may be used to build a statistical classification model. This statistical classification model is then used for performing facies type classification elsewhere in the reservoir geological formation. Typically, seismic measurements may be performed on the reservoir geological formation, and the resulting seismic traces may be inverted to obtain a 3D seismic image which represents values of one or more geophysical properties associated with respective portions of the reservoir geological formation. For instance, these geophysical property values may be included in a reservoir grid which corresponds to a 3D arrangement of cells, wherein each cell represents a respective portion of the reservoir geological formation. These geophysical property values are then processed on a cell-by-cell basis by the statistical classification model to obtain likelihoods of each facies type for each cell of the reservoir grid, i.e., for each portion of the reservoir geological formation.

However, existing supervised facies classification methods usually rely on training data in the form of a cross-plot for each considered facies type, each cross-plot providing a likelihood of one facies type as a function of two geophysical properties. Hence, such supervised facies classification methods are limited in the number of geophysical properties taken into account, and also in the types of seismic attributes taken into account.

Also, such supervised facies classification methods are performed on a cell-by-cell basis, without accounting for possible dependencies between the facies types of different cells/portions of the reservoir geological formation.

### BRIEF SUMMARY

The present disclosure aims at improving the situation. In particular, the present disclosure aims at overcoming at least some of the limitations of the prior art discussed above, by proposing a solution for facies type classification enabling to take into account an arbitrary number of different seismic attributes and/or new types of seismic attributes.

Also, in some embodiments at least, the proposed solution enables to account for possible dependencies between the facies types of different cells/portions of the reservoir geological formation.

According to a first aspect, the present disclosure relates to a computer implemented method for facies type classification in a reservoir geological formation, wherein the method comprises, for a considered portion among a plurality of portions composing the reservoir geological formation:
retrieving, from a 3D seismic image representing values of at least one geophysical property, the at least one geophysical property value associated with the considered portion,
retrieving, from a 4D seismic image representing values of at least one time-lapse geophysical property, the at least one time-lapse geophysical property value associated with the considered portion, and
for each of a plurality of different facies types: determining a facies type likelihood based on the retrieved at least one geophysical property value and based on the retrieved at least one time-lapse geophysical property value, wherein said facies type likelihood is representative of a probability that the considered portion belongs to said facies type and is determined by using a predetermined facies-type-specific multivariate probability distribution which takes as input variables the at least one geophysical property and the at least one time-lapse geophysical property.

Hence, the proposed solution relies on a plurality of facies-type-specific multivariate probability distributions in order to be able to take into account an arbitrary number of seismic attributes for facies type classification, each different seismic attribute being an input variable of the facies-type-specific multivariate probability distributions.

Also, these multivariate probability distributions can be used to introduce other types of seismic attributes which may be of interest for facies type classification. In particular, they may be used to introduce time-lapse geophysical properties, a.k.a. 4D geophysical properties.

Basically, a 3D seismic image of the reservoir geological formation represents the variation of at least one geophysical property in the 3D volume of the reservoir geological formation.

A 4D seismic image corresponds to a 3D image which represents values, referred to as time-lapse geophysical property values, representative of the variation of at least one geophysical property between seismic measurements performed on the reservoir geological formation and separated in time by a time-lapse interval. Hence, in a 4D seismic image, the fourth dimension corresponds to time. In practice, first seismic measurements are performed at a first calendar date, for instance before starting the exploitation of the reservoir geological formation. Second seismic measurements are performed at a second calendar date, for instance one or more years after the first calendar date. The 4D seismic image therefore represents the variation of at least one geophysical property in the 3D volume of the reservoir geological formation and over time, between the first and second calendar dates.

Hence the time-lapse geophysical property of a portion of the reservoir geological formation depends on how this portion has been influenced by the exploitation of the reservoir geological formation. Typically, a substantially null time-lapse geophysical property value indicates that no fluid was able to flow in the considered portion during the exploitation of the reservoir geological formation, which may be due to different factors and may happen for different facies types. However, an important time-lapse geophysical property absolute value will typically indicate that fluid was able to flow in the considered portion, such that the considered portion is likely to belong to a permeable facies type.

Hence, such multivariate probability distributions may be used to merge different types of seismic attributes, and more specifically information from 3D seismic images (i.e., geophysical properties) and from 4D seismic images (i.e., time-lapse geophysical properties), which enables to improve facies type classification by taking into account time-lapse geophysical properties. For instance, these multivariate probability distributions may be predetermined by using supervised techniques.

In specific embodiments, the facies classification method can further comprise one or more of the following optional features, considered either alone or in any technically possible combination.

In specific embodiments, the plurality of different facies types include at least one permeable facies type and at least one non-permeable facies type, and the facies-type-specific multivariate probability distributions are such that:
the facies type likelihood of the at least one permeable facies type increases with the at least one time-lapse geophysical property absolute value, and
the facies type likelihood of the at least one non-permeable facies type decreases with the at least one time-lapse geophysical property absolute value.

In specific embodiments, the facies-type-specific multivariate probability distributions are such that the facies type likelihoods are not influenced by the at least one time-lapse geophysical property value when the at least one time-lapse geophysical property absolute value is below a predetermined threshold.

In specific embodiments, the at least one geophysical property values and/or the at least one time-lapse geophysical property values are determined by seismic inversion of seismic traces obtained by performing seismic measurements on the reservoir geological formation.

In specific embodiments, the portions of the reservoir geological formation are arranged in columns, each column of portions extending along a depth of the reservoir geological formation, and the method comprises:
determining facies type likelihoods for each of the plurality of different facies types and for each portion of a column of portions, and
column-wise updating the facies type likelihoods determined for the column of portions by using a forward-backward algorithm and a predetermined transition matrix.

In specific embodiments, the transition matrix is predetermined based on measurements carried out at a well arranged in the reservoir geological formation.

In specific embodiments, the portions of the reservoir geological formation are arranged in columns, each column of portions extending along a depth of the reservoir geological formation, and a variance of at least one facies-type-specific multivariate probability distribution varies with an index of the considered portion in the column of portions.

In specific embodiments, the portions of the reservoir geological formation are arranged in columns, each column of portions extending along a depth of the reservoir geological formation, and said method comprises lateral-wise updating the facies-type likelihood of a considered portion based on a facies-type likelihood determined for the same facies-type for a corresponding portion of at least one other column.

In specific embodiments, lateral-wise updating the facies type likelihood of the considered portion comprises:
determining a prior facies type likelihood for the considered portion based on the facies type likelihood determined for the same facies type for the corresponding portion of the at least one other column, and
combining the prior facies type likelihood and the facies type likelihood determined for the considered portion.

In specific embodiments, the prior facies type likelihood for the considered portion is determined by kriging the facies type likelihood determined for the same facies type for the corresponding portion of the at least one other column.

In specific embodiments, the at least one other column of portions includes a reference column of portions which includes portions of the reservoir geological formation where a well is arranged in said reservoir geological formation, and the facies type likelihoods for portions of said reference column are determined based on measurements carried out at the well.

In specific embodiments, a corresponding portion of the considered portion corresponds to a portion of the reservoir geological formation which belongs to a same geological layer as the considered portion.

In specific embodiments, each facies-type-specific multivariate probability distribution is a multivariate normal distribution.

In specific embodiments, at least one facies-type-specific multivariate probability distribution is predetermined based on measurements carried out at at least one well arranged in the reservoir geological formation.

According to a second aspect, the present disclosure relates to a computer program product stored on a non-transitory computer-readable medium comprising instructions which, when executed by at least one processor, configure said at least one processor to carry out a facies type classification method according to any one of the embodiments of the present disclosure.

According to a third aspect, the present disclosure relates to a non-transitory computer-readable storage medium comprising instructions which, when executed by at least one processor, configure said at least one processor to carry out a facies type classification method according to any one of the embodiments of the present disclosure.

According to a fourth aspect, the present disclosure relates to a computer system comprising at least one processor and at least one memory, said at least one processor being configured to carry out a facies type classification method according to any one of the embodiments of the present disclosure.

### BRIEF DESCRIPTION OF THE SEVERAL VIEWS OF THE DRAWINGS

The disclosure will be better understood upon reading the following description, given as an example that is in no way limiting, and made in reference to the figures which show:

FIG. 1 is a flow chart illustrating the main steps of a method for facies type classification in a reservoir geological formation;

FIG. 2 is a schematic representation of examples of normal distributions for permeable and non-permeable facies types;

FIG. 3 is a flow chart illustrating the main steps of an exemplary embodiment of the facies type classification method;

FIG. 4 is a flow chart illustrating the main steps of another exemplary embodiment of the facies type classification method; and

FIG. 5 is a flow chart illustrating the main steps of another exemplary embodiment of the facies type classification method.

In these figures, references identical from one figure to another designate identical or analogous elements. For reasons of clarity, the elements shown are not to scale, unless explicitly stated otherwise.

Also, the order of steps represented in these figures is provided only for illustration purposes and is not meant to limit the present disclosure which may be applied with the same steps executed in a different order.

### DETAILED DESCRIPTION

As discussed above, the present disclosure relates inter alia to a method 10 for facies type classification in an underground reservoir geological formation. For instance, the facies type classification method 10 may be used for hydrocarbon (oil, natural gas, shale gas, etc.) recovery from the reservoir geological formation and/or for carbon dioxide storage in said reservoir geological formation.

The facies type classification method 10 is carried out by a computer system (not represented in the figures). In preferred embodiments, the computer system comprises one or more processors and one or more memories. The one or more processors may include for instance a central processing unit (CPU), a graphical processing unit (GPU), a digital signal processor (DSP), a field-programmable gate array (FPGA), an application specific integrated circuit (ASIC), etc. The one or more memories may include any type of computer readable volatile and non-volatile memories (magnetic hard disk, solid-state disk, optical disk, electronic memory, etc.). The one or more memories may store a computer program product on a computer-readable storage medium, in the form of a set of program-code instructions to be executed by the one or more processors in order to implement all or part of the steps of the facies type classification method 10.

In geology, a facies type is a body of rock with specified characteristics, which can be any observable attribute of rocks (such as their overall appearance, composition, or condition of formation), and the changes that may occur in those attributes over a geographic area. A facies type may encompass all of the characteristics of a rock including its chemical, physical, and biological features that distinguish it from adjacent rock. Simple facies types may correspond for instance to sand, shale, silt, etc. More complex facies types may for instance correspond to marine silty shale, pro delta, flood plain, mouth bar, distributary channel, crevasse splay, tidal deltaic lobes, tight formations, etc.

Facies type classification in a reservoir geological formation generally means estimating, for each of a plurality of portions of the reservoir geological formation, the facies type to which each portion belongs. In the present disclosure, we consider more specifically a statistical facies type classification which aims at considering a plurality of predetermined different possible facies types (e.g., sand, shale and silt) for each considered portion of the reservoir geological formation and determining a facies-type likelihood for each considered different possible facies type, wherein the facies-type likelihood is representative of a probability that the considered portion belongs to said possible facies type.

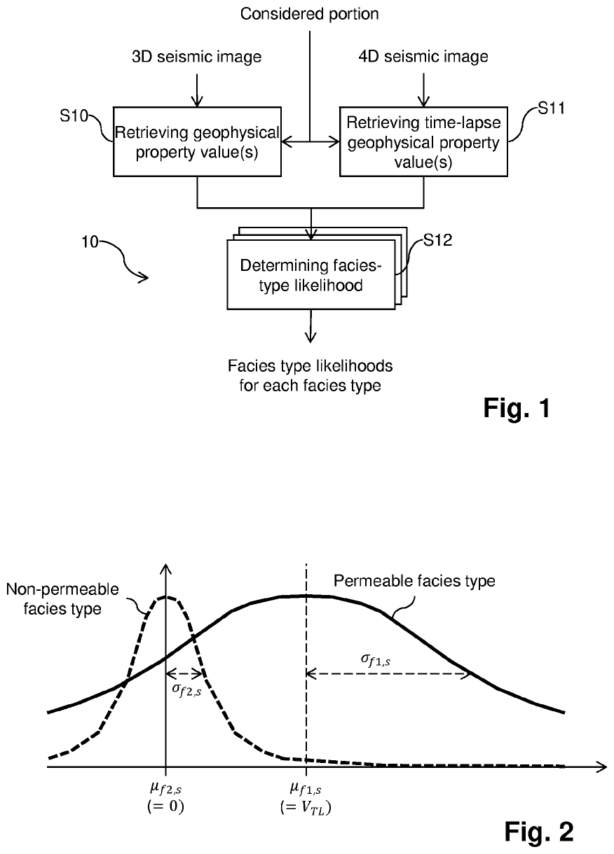

FIG. 1 represents schematically the main steps of an exemplary embodiment of a method 10 for facies type classification in the reservoir geological formation.

As illustrated by FIG. 1, the facies type classification method 10 comprises, for each considered portion of the reservoir geological formation, a step S10 of retrieving, from a 3D seismic image representing all or part of the reservoir geological formation, at least one geophysical property value estimated for the considered portion of the reservoir geological formation.

Basically, the 3D seismic image represents all or part of the 3D volume of the reservoir geological formation, as a 3D grid of cells wherein each cell corresponds to a respective volume element of the 3D grid which may be substantially cubic or have a more complex shape. Each cell of the 3D seismic image is mapped to at least one corresponding portion of the reservoir geological formation. Each cell includes one or more values of respective one or more geophysical properties. Each geophysical property may be any geophysical property known to the skilled person, for instance the V_{P}/V_{S} ratio, the Poisson ratio, the density, the P and S velocities or impedances, etc. For instance, the geophysical property values of the 3D seismic image are determined by seismic inversion of seismic traces obtained by performing seismic measurements on the reservoir geological formation. Hence, step S10 includes identifying in the 3D seismic image at least one cell which represents the considered portion of the reservoir geological formation and retrieving the one or more geophysical property values stored in said at least one cell.

As illustrated by FIG. 1, the facies type classification method 10 also comprises, for the considered portion of the reservoir geological formation, a step S11 of retrieving, from a 4D seismic image representing all or part of the reservoir geological formation, at least one time-lapse geophysical property value estimated for the considered portion of the reservoir geological formation.

Basically, the 4D seismic image represents all or part of the 3D volume of the reservoir geological formation, as a 3D grid of cells wherein each cell corresponds to a respective volume element of the 3D grid which may be substantially cubic or have a more complex shape. Each cell of the 4D seismic image is mapped to at least one corresponding portion of the reservoir geological formation. Each cell includes one or more values of respective one or more time-lapse geophysical properties. As discussed above, a time-lapse geophysical property is representative of the variation of a geophysical property between first seismic measurements and second seismic measurements separated in time by a time-lapse interval. Each time-lapse geophysical property may be any time-lapse geophysical property known to the skilled person. For instance, the time-lapse geophysical property may correspond to e.g.:
a relative seismic wave velocity change (ΔV_{P}/V_{P} or ΔV_{S}/V_{S}), representative of the variation of the geophysical property corresponding to the seismic wave velocity V_{P} or V_{S};
a relative acoustic impedance change (ΔI_{P}/I_{P}), representative of the variation of the geophysical property corresponding to the acoustic impedance I_{P};
a relative density change (Δρ/φ, representative of the variation of the geophysical property corresponding to the rock density ρ; and
a relative time strain change (Δτ/τ), representative of the variation of the geophysical property corresponding to the time strain τ; etc.

Regardless the type of time-lapse geophysical property considered, the 4D seismic image is representative of how the reservoir geological formation has been modified, e.g., by its exploitation via a well, between the first seismic measurements and the second seismic measurements. For instance, in the case of an exploitation of the reservoir geological formation by means of an injection well, the 4D seismic image is representative of where hydrocarbons (e.g., oil) have been replaced by the injected fluid (e.g., water). For instance, the time-lapse geophysical property values of the 4D seismic image are determined by seismic inversion of seismic traces obtained by performing said first and second seismic measurements on the reservoir geological formation.

Hence, step S11 includes identifying in the 4D seismic image at least one cell which represents the considered portion of the reservoir geological formation and retrieving the one or more time-lapse geophysical property values stored in said at least one cell.

It should be noted that a time-lapse geophysical property represented by the 4D seismic image may represent the variation over time of a geophysical property represented by the 3D seismic image, or another geophysical property that is not represented by the 3D seismic image. In other words, if the 3D seismic image represents the density, the 4D seismic image is not required to represent the relative density change Δρ/ρ (or the density change Δρ) and may represent, e.g., the relative seismic wave velocity change (ΔV_{P}/V_{P} or the relative acoustic impedance change ΔI_{P}/I_{P}, etc.

Also, it is emphasized that, in the present disclosure, a reference to a “geophysical property” without explicitly stating that it is a “time-lapse” geophysical property implies that it is not a time-lapse geophysical property (i.e., it is a 3D geophysical property and not a 4D geophysical property). As used herein, “seismic attribute” means either a geophysical property or a time-lapse geophysical property.

Hence, after step S10 and step S11, at least two values of different seismic attributes have been retrieved for the considered portion, i.e., at least one value of a geophysical property and at least one value of a time-lapse geophysical property. In preferred embodiments, the facies type classification method 10 uses more than two different seismic attributes, for instance at least two or three geophysical properties (e.g., the V_{P}/V_{S} ratio, the impedance I_{P} and the density) and at least one time-lapse geophysical property value (e.g., the relative density change). Hence, if we denote by N_{S} the number of seismic attributes retrieved, then N_{S}≥2 and preferably N_{S}≥3 or even N_{S}≥4.

As discussed above, in the context of statistical facies type classification, a facies-type likelihood is determined for each of a plurality of predetermined different facies types considered as possibly present in the reservoir geological formation. As illustrated by FIG. 1, the facies type classification method 10 comprises, for each considered portion of the reservoir geological formation, a plurality of steps S12 of determining a facies-type likelihood, one for each of the plurality of different possible facies types.

The way such different possible facies types may be predetermined for a given reservoir geological formation is out of scope of the present disclosure and is considered known to the skilled person. For instance, the different possible facies types may correspond to sand, shale and silt, in which case the facies type classification method 10 computes, for each considered portion of the reservoir geological formation:
a sand likelihood representative of the probability that the considered portion corresponds to sand;
a shale likelihood representative of the probability that the considered portion corresponds to shale; and
a silt likelihood representative of the probability that the considered portion corresponds to silt.

In the present disclosure, each facies-type likelihood is determined based on the seismic attribute values retrieved during steps S10 and S11, by using a predetermined facies-type-specific multivariate probability distribution which takes as input variables the retrieved seismic attributes (i.e., the at least one geophysical property and the at least one time-lapse geophysical property). Hence, there are different predetermined multivariate probability distributions, one for each different possible facies type. Accordingly, if there are N_{F} different possible facies types, there are N_{F} different facies-type-specific multivariate probability distributions.

Hence, the proposed solution relies on a plurality of facies-type-specific multivariate probability distributions in order to be able to take into account an arbitrary number of seismic attributes for facies type classification, each different seismic attribute being an input variable of the facies-type-specific multivariate probability distributions.

For instance, these multivariate probability distributions may be predetermined by using supervised techniques. In some embodiments, at least one facies-type-specific multivariate probability distribution (and preferably all of them) may be predetermined based on measurements carried out at at least one well drilled in the reservoir geological formation. For instance, the different possible facies types may be identified along each well drilled in the reservoir geological formation. Also, the seismic attributes considered as input variables, or at least the geophysical properties considered as input variables, may be measured along each well. Hence, for each different possible facies type identified along the well(s), corresponding values of the considered seismic attributes or geophysical properties are obtained, which can be used as training data for determining the parameters (e.g., mean, variance, etc.) of each facies-type-specific multivariate probability distribution.

The dependency of the multivariate probability distributions on the time-lapse geophysical property may be addressed similarly, or in a specific manner. Indeed, the time-lapse geophysical property of a portion of the reservoir geological formation depends on how this portion has been influenced by the exploitation of the reservoir geological formation. Typically, a substantially null time-lapse geophysical property value indicates that no fluid was able to flow in the considered portion during the exploitation of the reservoir geological formation, which may be due to different factors and may happen for different facies types. However, an important time-lapse geophysical property absolute value will typically indicate that fluid was able to flow in the considered portion, such that the considered portion is likely to belong to a permeable facies type. The dependency of the multivariate probability distributions on the time-lapse geophysical property may be defined according to these principles.

For instance, the facies-type-specific multivariate probability distributions may be such that the likelihoods of the facies types are not influenced by the at least one time-lapse geophysical property value when the at least one time-lapse geophysical property absolute value is below a predetermined threshold. Indeed, in such a case (low absolute value for the time-lapse geophysical property), this indicates that no fluid was able to flow in the considered portion during the exploitation of the reservoir geological formation, which may be due to different factors and may happen for different facies types. In other words, when considering only the time-lapse geophysical property, then all different possible facies types may be considered equally likely when the time-lapse geophysical property absolute value is low, e.g., substantially null.

In turn, for absolute values above the predetermined threshold (i.e., for large absolute values), then this indicates that fluid was able to flow in the considered portion, such that a permeable facies type is more likely than a non-permeable facies type. Hence, if the different possible facies types include at least one permeable facies type (e.g., sand) and at least one non-permeable facies type (e.g., shale), then the facies-type-specific multivariate probability distributions should be such that:
the facies type likelihood of the at least one permeable facies type increases with the at least one time-lapse geophysical property absolute value, and
the facies type likelihood of the at least one non-permeable facies type decreases with the at least one time-lapse geophysical property absolute value.

In preferred embodiments, each facies-type-specific multivariate probability distribution is a multivariate normal distribution. In such a case, the multivariate normal distribution MG_{f} for the facies type of index f 1≤f≤N_{F} may be expressed as:

$$M {G}_{f} ( {e}_{1} , {e}_{2} , … , {e}_{{N}_{S}} ) = \frac{1}{\sqrt{{( 2 π )}^{{N}_{S}} \vert Σ \vert}} exp ( - \frac{1}{2} {( e - {μ}_{f} )}^{T} {Σ}_{f}^{- 1} ( e - {μ}_{f} ) ) \qquad [ Math . 1 ]$$

wherein:
e_{S} corresponds to the input variable (seismic attribute) of index s (1≤s≤N_{S} with N_{S}≥2 the number of seismic attributes considered as input to the multivariate normal distributions);
e=[e₁,e₂, . . . , e_{N}_{_{S}}]^{T};
μ_{f,s} is the mean of the input variable of index s for the multivariate normal distribution MG_{f} of the facies type of index f;
μ_{f}=[μ_{f,1}, μ_{f,2}, . . . , μ_{f,N}_{_{S}}]^{T};
Σ_{f} is a symmetric covariance matrix of all pairs of input variables (seismic attributes); and
   |Σ_{f}| is the determinant of Ef.

For instance, the training data may be used to determine, e.g., the mean vector μ_{f} and the covariance matrix Ef for each multivariate normal distribution MG_{f} (1≤f≤N_{F}), by using methods considered known to the skilled person. In case the distribution is not gaussian for one or more input variables (e.g., for the time-lapse geophysical property), it is possible to use, e.g., a normal score transform to transform the initial distribution into a gaussian distribution.

For instance, in order to have a dependency of the multivariate probability distributions on the time-lapse geophysical property that complies with the above-mentioned principles, it is possible to define a threshold V_{TL}. This threshold V_{TL} may be determined for instance based on a level of a measurement noise present in the time-lapse geophysical property values. If the time-lapse geophysical property absolute value is below this threshold V_{TL}, then it is low and cannot be distinguished from noise. If the time-lapse geophysical property absolute value is above this threshold V_{TL}, then it may be considered that the corresponding portion has been influenced by its exploitation over time. FIG. 2 represents schematically examples of normal distributions that may be considered for implementing the dependency on the time-lapse geophysical property. For instance, for a permeable facies type (e.g., sand), the mean μ_{f1,s} of the normal distribution implementing the dependency on the time-lapse geophysical property value (or on its absolute value) may be set close to the predetermined threshold V_{TL} (equal in the example illustrated by FIG. 2) and the variance σ²_{f1,s} may be such that the standard deviation σ_{f1,s} is greater than the mean μ_{f1,s}, preferably at least two times the mean μ_{f1,s} or three times the mean μ_{f1,s} or more. For a non-permeable facies type (e.g., shale), the mean μ_{f2,s} of the normal distribution implementing the dependency on the time-lapse geophysical property value (or on its absolute value) may be set close to zero (and in any case below the predetermined threshold V_{TL}) and the variance σ²_{f2,s} may be such that the standard deviation σ_{f2,s} is equal to or lower than the predetermined threshold, preferably half the predetermined threshold or even less (such that large time-lapse geophysical property absolute values are unlikely).

In some cases, the variance may be adjusted to introduce some prior knowledge on the spatial distribution of one or more facies types. In particular, it may be advantageous in some cases to adjust the variance depending on a depth of the considered portion. For instance, if the approximate depth of a water-oil contact (WOC) is known, then there cannot be water sand above the WOC. Hence, if one of the possible facies types is water sand, its variance may vary with the depth of the considered portion, such that it tends to zero around the WOC and is substantially equal to zero above the WOC. Assuming that the portions of the reservoir geological formation are arranged in columns and that each portion has an associated index k representative of the depth of said portion (for instance k=1 for the shallowest portion in the column and k=N_{D} for the deepest portion), then the variance may vary with the index of the considered portion. Hence, in such a case, the covariance matrix Σ_{f} (k) depends on the index k. In the previous example with the water sand facies type, the trace of the covariance matrix Σ_{f}(k) may tend to zero around the WOC and may be substantially equal to zero above the WOC. It should be noted that the index of the WOC may vary from one column of portions to another.

In the case of multivariate normal distributions, the facies type likelihoods may be computed by directly using the expressions [Math. 1] above. However, in some embodiments, these expressions may be approximated as follows to compute the facies type likelihoods.

For instance, for each different possible facies type and each considered seismic attribute, a distance in the normal space is computed as follows:

N_{f,s}=(eₛ−μ_{f,s})/σ_{f,s}

Then a correlation for each pair of seismic attributes of indexes si and sj is computed as follows:

$${s}_{f}^{si , sj} = \frac{{N}_{f , si} + {N}_{f , sj}}{\sqrt{2 + 2 {ρ}_{f}^{si , sj}}}$$

$${d}_{f}^{si , sj} = \frac{{N}_{f , si} - {N}_{f , sj}}{\sqrt{2 - {ρ}_{f}^{si , sj}}}$$

wherein ρ_{f}^{si,sj} is the correlation coefficient retrieved from the covariance matrix Σ_{f}. The previous equations come from the fact that N_{f,s} is distributed according to a normal distribution with mean 0 and variance 1 with correlation coefficients ρ_{f}^{si,sj}. Hence, the standard deviation of the sum (N_{f,si}+N_{f,sj}) is given by:

\sqrt{2+2ρ_{f}^{si,sj}}

and the covariance of the difference (N_{f,si}−N_{f,sj}) is given by:

\sqrt{2−2ρ_{f}^{si,sj}}

Then the facies type likelihood L_{f} for the facies type of index f may be computed as follows:

$${L}_{f}^{2} = {\sum }_{s = 1}^{{N}_{S}} {N}_{f , s}^{2} + {\sum }_{s i = 1}^{{N}_{S}} {\sum }_{s j = 1}^{{N}_{S}} ( {( {s}_{f}^{si , sj} )}^{2} + {( {d}_{f}^{si , sj} )}^{2} )$$

In preferred embodiments, the facies type likelihoods are normalized to produce normalized facies type likelihoods p_{f}:

$${p}_{f} = \frac{{L}_{f}}{{\sum }_{f = 1}^{{N}_{F}} {L}_{f}}$$

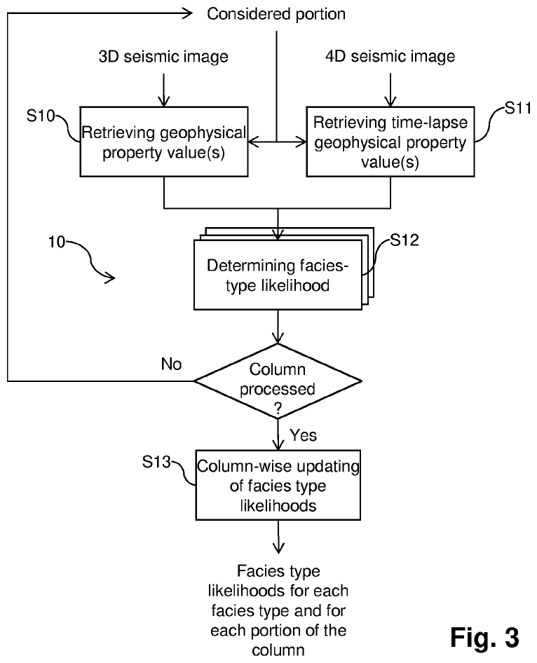

FIG. 3 represents schematically a preferred embodiment of the facies type classification method 10. As illustrated by FIG. 3, the steps S10, S11 and S12 are repeated for each portion of a considered column of portions, such that facies type likelihoods are determined for each of the plurality of different possible facies types and for each portion of the considered column. Once all portions of the considered column have been processed, the facies type classification method 10 comprises in this example a step S13 of column-wise updating the likelihoods of the facies types determined for the column of portions by using a forward-backward algorithm and a predetermined transition matrix.

The forward-backward algorithm is a well-known inference algorithm for hidden Markov models which computes the posterior marginals of all hidden state variables given a sequence of observations. In the present case, the hidden state variables {X₁, X₂, . . . , X_{N}_{_{F}}}correspond respectively to the different possible facies types. The sequence of observations corresponds for instance to the normalized facies type likelihoods p_{f}(k) determined for each different possible facies type and for each portion k of the considered column, which may be included in the so-called event matrix B of the forward-backward algorithm. Hence, the forward-backward algorithm computes, for all hidden state variables {X₁, X₂, . . . , X_{N}_{_{F}}}, the probability P(X_{f}/B) which corresponds to the column-wise updated facies type likelihood. The probabilities P(X_{f}/B) may be initialized to the unknown probabilities, i.e., P(X_{f}/B)=1/N_{f} for any 1≤f≤N_{F}. The forward-backward algorithm also uses a transition matrix which, in the present case, represents the probabilities of transitioning from one possible facies type to another possible facies type. The transition matrix may for instance be determined based on geological models and/or based on measurements carried out at one or more wells drilled in the reservoir geological formation.

The forward-backward algorithm enables to introduce a dependency between portions of a same column of portions, and also to introduce a prior knowledge on the different possible facies types (i.e., the transition matrix), which enable to improve the accuracy of the estimated facies type likelihoods.

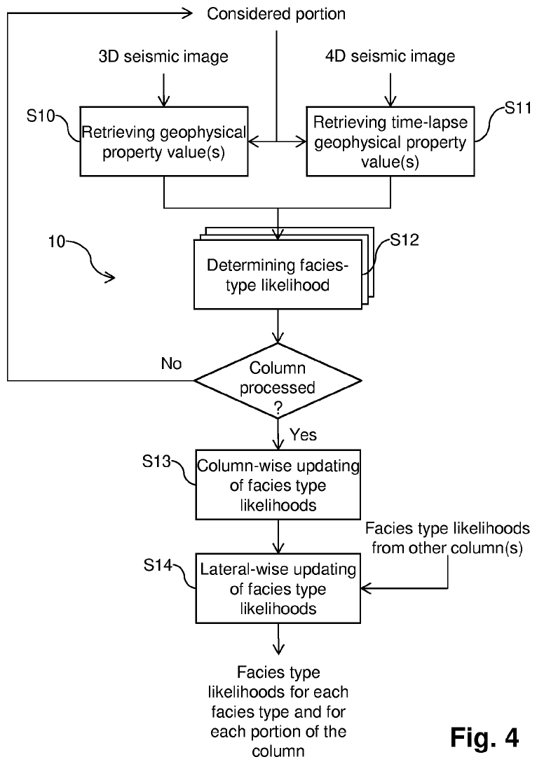

FIG. 4 represents schematically a preferred embodiment of the facies type classification method 10, in which a lateral dependence is taken into account. Indeed, the facies types of adjacent portions, at least within a same geological layer, are in principle correlated such that the likelihoods of the facies types determined for other portions of the same geological layer can be used to update the likelihoods o the facies types of a considered portion.

As illustrated by FIG. 4, the illustrated embodiment comprises all steps illustrated by FIG. 3. After the step S13 of column-wise updating the likelihoods of the facies types determined for a given column of portions, the dependence between neighbor columns is taken into account during a step S14 of lateral-wise updating the facies-type likelihood of a considered portion based on a facies-type likelihood determined for the same facies-type for a corresponding portion of at least one other column.

Basically, a “corresponding portion” is a portion of another column which is likely to exhibit a strong facies-type correlation with the considered portion. For instance, portions considered to correspond to a same geological layer are “corresponding portions” and their actual facies types can be considered to be correlated. Such corresponding portions may be determined by using any known method known to the skilled person. For instance, it is possible to compute seismic horizons which can be used to identify portions of the reservoir geological formation which can be considered to be corresponding portions, i.e., portions considered to belong to a same geological layer. Such seismic horizons can be determined based on seismic measurements carried out on the reservoir geological formation, for instance the seismic measurements which have led to the 3D seismic image.

Hence, the embodiment of FIG. 4 aims at using, for a considered portion of a given column, the information already available for other columns of portions of the reservoir geological formation. Typically, the columns of portions of the reservoir geological formation may be processed successively, in a deterministic and/or random order. Each time a column of portions has been processed by the facies type classification method 10, it can be used for lateral-wise updating subsequent columns of portions. Hence, the lateral-wise updating of a considered portion of a given column may use one or more previously processed columns of portions, i.e., columns of portions for which facies type likelihoods are already available. In some cases, it is also possible to include at least one reference column of portions which corresponds to portions where a well is drilled in the reservoir geological formations. Hence, for a reference column of portions, the likelihoods of the facies types can be obtained by direct measurements carried out at the well. Typically, at a well, the facies type of each portion of the reference column can usually be accurately identified, such that the likelihood of the correct facies type of a portion will tend towards 1 while the likelihoods of the other facies types will tend towards 0. Hence, the lateral-wise updating step S14 may also be used to propagate reference facies types likelihoods, determined for a reference column, towards neighbor columns.

In preferred embodiments, lateral-wise updating the facies type likelihood of a considered portion comprises determining a prior facies type likelihood for said considered portion based on the facies type likelihood determined for the same facies type for the corresponding portion of one or more other columns (e.g., previously processed one or more other columns and/or one or more reference columns). Basically, the prior facies type likelihood of the considered portion corresponds to a facies type likelihood determined for the considered portion by using only data from the one or more other columns. Such a prior facies type likelihood is computed for each different possible facies type. For instance, if the possible facies types are sand, shale and silt, then:
the prior sand likelihood of the considered portion is determined based on the prior sand likelihood(s) of one or more corresponding portions in other columns;
the prior shale likelihood of the considered portion is determined based on the prior shale likelihood(s) of one or more corresponding portions in other columns; and
the prior silt likelihood of the considered portion is determined based on the prior silt likelihood(s) of one or more corresponding portions in other columns.

For instance, the prior facies type likelihood for the considered portion is determined by kriging the facies type likelihood(s) (for the same facies type) of the corresponding portion(s) in other columns of portions. However, any interpolation/extrapolation method known to the skilled person may be used for determining the prior facies type likelihoods.

Then, the updated facies type likelihood for the considered portion is determined by combining:
the prior facies type likelihoods determined for the considered portion based on the corresponding portions of other columns; and
the facies type likelihood determined for the considered portion by feeding the facies-type-specific multivariate probability distribution with the seismic attribute values retrieved (from the 3D and 4D seismic images) for the considered portion (and, in the example of FIG. 4, after column-wise updating the considered portion).

This is performed for each different possible facies type. For instance, the (lateral-wise) updated facies type likelihood may be determined as being the maximum a posteriori probability. If we denote by L′_{f} [k] the facies type likelihood obtained after the column-wise updating step S13 for the considered portion of index k and for the facies type of index f, then the (lateral-wise) updated facies type likelihood L″_{f}[k] may for instance be expressed as:

$${L}_{f}^{″} [ k ] = \frac{P {L}_{f} [ k ] \times v L + {L}_{f}^{′} [ k ] \times v P [ k ]}{v L + v P [ k ]}$$

expression in which:
PL_{f}[k] corresponds to the prior facies type likelihood determined for the facies type of index f and for the considered portion of index k by using the facies type likelihoods determined for the facies type of index f and for corresponding portions in other columns;
vP[k] corresponds to an estimated variance of PL_{f}[k], for instance provided by the kriging algorithm; and
0≤vL≤1 corresponds to a predetermined coefficient, which may be, e.g., defined by a user, which represents a confidence on the seismic measurements; for instance vL=0.8, but it can be diminished to, e.g., introduce more continuity and/or if the seismic measurements are very noisy.

Of course, other expressions may be used for the computation of the (lateral-wise) updated facies type likelihoods.

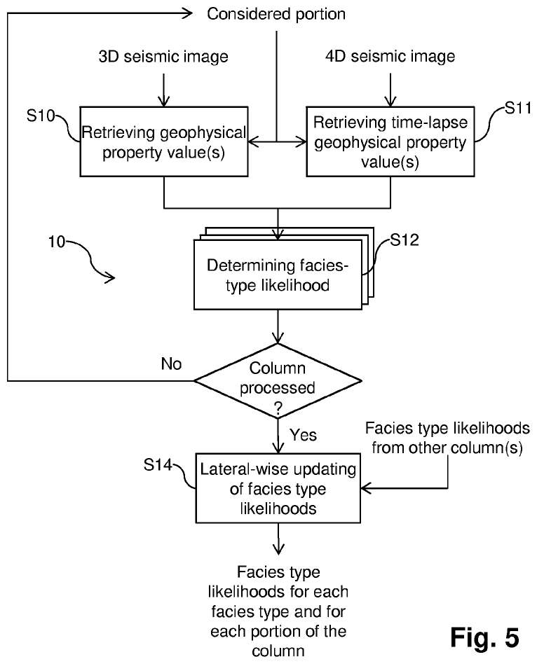

In FIG. 4, both a column-wise update (step S13) and a lateral-wise update (step S14) are performed. However, the step S14 of lateral-wise updating the facies type likelihoods can also be executed alone, without executing the step S13 of column-wise updating, as illustrated by FIG. 5.

It is emphasized that the present disclosure is not limited to the above exemplary embodiments. Variants of the above exemplary embodiments are also within the scope of the present disclosure.

The above description clearly illustrates that by its various features and their respective advantages, the present disclosure reaches the goals set for it, by proposing a plurality of facies-type-specific multivariate probability distributions which take as input parameters a plurality of different seismic attributes which include both geophysical properties and time-lapse geophysical properties. Also, the column-wise updating step S13 and/or the lateral-wise updating step S14, when optionally executed, enable to account for possible dependencies between the facies types of different cells/portions of the reservoir geological formation.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled.

1. A computer implemented method for facies type classification in a reservoir geological formation, wherein the method comprises:
for a considered portion among a plurality of portions composing the reservoir geological formation:
retrieving, from a 3D seismic image representing values of at least one geophysical property, at least one geophysical property value associated with the considered portion,
retrieving, from a 4D seismic image representing values of at least one time-lapse geophysical property, at least one time-lapse geophysical property value associated with the considered portion, and
for each of a plurality of different facies types, determining a facies type likelihood based on the retrieved at least one geophysical property value and based on the retrieved at least one time-lapse geophysical property value, wherein said facies type likelihood is representative of a probability that the considered portion belongs to said facies type and is determined by using a predetermined facies-type-specific multivariate probability distribution which takes as input variables the at least one geophysical property and the at least one time-lapse geophysical property.

2. The method according to claim 1, wherein the plurality of different facies types include at least one permeable facies type and at least one non-permeable facies type, and the facies-type-specific multivariate probability distribution is such that:
the facies type likelihood of the at least one permeable facies type increases with an absolute value of the at least one time-lapse geophysical property, and
the facies type likelihood of the at least one non-permeable facies type decreases with the absolute value of the at least one time-lapse geophysical property.

3. The method according to claim 2, wherein the facies-type-specific multivariate probability distribution is such that the facies type likelihood is not influenced by the at least one time-lapse geophysical property value when the absolute value of the at least one time-lapse geophysical property is below a predetermined threshold.

4. The method according to claim 1, wherein the at least one geophysical property value and/or the at least one time-lapse geophysical property value is determined by seismic inversion of seismic traces obtained by performing seismic measurements on the reservoir geological formation.

5. The method according to claim 1, wherein the plurality of portions of the reservoir geological formation are arranged in columns, each column of portions extending along a depth of the reservoir geological formation, and the method comprises:
determining facies type likelihoods for each of the plurality of different facies types and for each portion of a column of portions, and
column-wise updating the facies type likelihoods determined for the column of portions by using a forward-backward algorithm and a predetermined transition matrix.

6. The method according to claim 5, wherein the transition matrix is predetermined based on measurements carried out at a well arranged in the reservoir geological formation.

7. The method according to claim 1, wherein the portions of the reservoir geological formation are arranged in columns, each column of portions extending along a depth of the reservoir geological formation, and wherein a variance of at least one facies-type-specific multivariate probability distribution varies with an index of the considered portion in the column of portions.

8. The method according to claim 1, wherein the portions of the reservoir geological formation are arranged in columns, each column of portions extending along a depth of the reservoir geological formation, and wherein said method comprises lateral-wise updating the facies-type likelihood of the considered portion based on a facies-type likelihood determined for a same facies-type for a corresponding portion of at least one other column.

9. The method according to claim 8, wherein lateral-wise updating the facies type likelihood of the considered portion comprises:
determining a prior facies type likelihood for the considered portion based on the facies type likelihood determined for the same facies type for the corresponding portion of the at least one other column, and
combining the prior facies type likelihood and the facies type likelihood determined for the considered portion.

10. The method according to claim 9, wherein the prior facies type likelihood for the considered portion is determined by kriging the facies type likelihood determined for the same facies type for the corresponding portion of the at least one other column.

11. The method according to claim 8, wherein the at least one other column of portions includes a reference column of portions which includes portions of the reservoir geological formation where a well is arranged in said reservoir geological formation, and wherein the facies type likelihoods for a portion of said reference column is determined based on measurements carried out at the well.

12. The method according to claim 8, wherein a corresponding portion of the considered portion corresponds to a portion of the reservoir geological formation which belongs to a same geological layer as the considered portion.

13. The method according to claim 1, wherein each facies-type-specific multivariate probability distribution is a multivariate normal distribution.

14. The method according to claim 1, wherein at least one facies-type-specific multivariate probability distribution is predetermined based on measurements carried out at at least one well arranged in the reservoir geological formation.

15. A computer program product comprising instructions stored on a non-transitory computer-readable storage medium which, when executed by at least one processor, configure the at least one processor to carry out the facies type classification method according to claim 1.

16. A non-transitory computer-readable storage medium comprising instructions which, when executed by at least one processor, configure the at least one processor to carry out the facies type classification method according to claim 1.

17. A computer system comprising at least one processor and at least one memory, the at least one processor being configured to carry out the facies type classification method according to claim 1.
